(19) United States
(12) Patent Application Publication
(10) Pub. No.: US 2015/0271608 A1
(43) Pub. Date: Sep. 24, 2015

(54) CROWD SOURCED RECOMMENDATIONS FOR HEARING ASSISTANCE DEVICES

(71) Applicant: Bose Corporation, Framingham, MA (US)

(72) Inventor: Andrew Sabin, Chicago, IL (US)

(21) Appl. No.: 14/662,951

(22) Filed: Mar. 19, 2015

Related U.S. Application Data
(60) Provisional application No. 61/955,451, filed on Mar. 19, 2014.

(51) Int. Cl. H04R 25/00

(52) U.S. Cl. CPC H04R 25/30

(57) ABSTRACT

The technology described in this document can be embodied in a computer-implemented method that includes causing, by one or more processing devices, a user-interface to be displayed on a display device, the user-interface including one or more controls for providing information to adjust a hearing assistance device, and transmitting a request for a recommended set of parameters for adjusting the hearing assistance device in an acoustic environment. The request includes identification information associated with (i) a user of the hearing assistance device and (ii) the acoustic environment. The method also includes receiving, from a remote computing device, and responsive to the request, the recommended set of parameters, and receiving, via the one or more controls, information indicative of adjustments to at least a subset of the recommended set of parameters. The method further includes providing the adjusted set of parameters to the hearing assistance device.

### PRIORITY CLAIM

This application claims priority to U.S. Provisional Application No. 61/955,451, filed on Mar. 19, 2014, the entire content of which is incorporated herein by reference.

### TECHNICAL FIELD

This disclosure generally relates to hearing assistance devices.

### BACKGROUND

Hearing assistance devices, such as hearing aids and personal sound amplifiers may need to be adjusted as a user moves from one type of acoustic environment to another. For example, a hearing assistance device can be configured to operate in multiple preset modes, and a user may choose different present modes in different acoustic environments.

### SUMMARY

In one aspect this document features a computer-implemented method that includes receiving, by one or more processing devices, information indicative of an initiation of an adjustment of a hearing assistance device, and determining, by the one or more processing devices, features associated with (i) a user of the hearing assistance device and (ii) an acoustic environment of the hearing assistance device. The method also includes obtaining, based on the features, a recommended set of parameters associated with the adjustment, wherein the recommended set of parameters are based on parameters used by a plurality of users in different acoustic environments, and providing the recommended set of parameters to the hearing assistance device.

In another aspect, this document features a computer-implemented method that includes causing, by one or more processing devices, a user-interface to be displayed on a display device, the user-interface including one or more controls for providing information to adjust a hearing assistance device, and transmitting a request for a recommended set of parameters for adjusting the hearing assistance device in an acoustic environment. The request includes identification information associated with (i) a user of the hearing assistance device and (ii) the acoustic environment. The method also includes receiving, from a remote computing device, and responsive to the request, the recommended set of parameters, and receiving, via the one or more controls, information indicative of adjustments to at least a subset of the recommended set of parameters. The method further includes providing the adjusted set of parameters to the hearing assistance device.

In another aspect, this document features one or more processing devices and memory. The one or more processing devices are configured to receive information indicative of an initiation of an adjustment of a hearing assistance device, and determine features associated with (i) a user of the hearing assistance device and (ii) an acoustic environment of the hearing assistance device. The one or more processing devices are also configured to obtain, based on the features, a recommended set of parameters associated with the adjustment. The recommended set of parameters are based on parameters used by a plurality of users in different acoustic environments. The one or more processing devices are further configured to provide the recommended set of parameters to the hearing assistance device.

In another aspect, this document features a system that includes one or more processing devices and memory. The one or more processing devices are configured to configured to cause a user-interface to be displayed on a display device, the user-interface including one or more controls for providing information to adjust a hearing assistance device, and transmit a request for a recommended set of parameters for adjusting the hearing assistance device in an acoustic environment, the request comprising identification information associated with (i) a user of the hearing assistance device and (ii) the acoustic environment. The one or more processing devices are further configured to receive, from a remote computing device, and responsive to the request, the recommended set of parameters, and receive, via the one or more controls, information indicative of adjustments to at least a subset of the recommended set of parameters. The one or more processing devices are also configured to provide the adjusted set of parameters to the hearing assistance device.

In another aspect this document features one or more machine-readable storage devices having encoded thereon computer readable instructions for causing one or more processors to perform various operations. The operations include receiving information indicative of an initiation of an adjustment of a hearing assistance device, and determining features associated with (i) a user of the hearing assistance device and (ii) an acoustic environment of the hearing assistance device. The operations also include obtaining, based on the features, a recommended set of parameters associated with the adjustment, wherein the recommended set of parameters are based on parameters used by a plurality of users in different acoustic environments, and providing the recommended set of parameters to the hearing assistance device.

In another aspect this document features one or more machine-readable storage devices having encoded thereon computer readable instructions for causing one or more processors to perform various operations. The operations include causing, by one or more processing devices, a user-interface to be displayed on a display device, the user-interface including one or more controls for providing information to adjust a hearing assistance device, and transmitting a request for a recommended set of parameters for adjusting the hearing assistance device in an acoustic environment. The request includes identification information associated with (i) a user of the hearing assistance device and (ii) the acoustic environment. The operations also include receiving, from a remote computing device, and responsive to the request, the recommended set of parameters, and receiving, via the one or more controls, information indicative of adjustments to at least a subset of the recommended set of parameters. The operations further include providing the adjusted set of parameters to the hearing assistance device.

Implementations of the above aspects can include one or more of the following.

The adjustment can be initiated based on data representing a user-input obtained via a user-interface. The adjustment can be automatically initiated based on a change in the acoustic environment for the hearing assistance device. Obtaining the recommended set of parameters can include providing the features to a remote computing device, and receiving the recommended set of parameters from the remote computing device in response to providing the features.

The recommended set of parameters can be based on parameters used by a plurality of users in different acoustic environments. The recommended set of parameters can be transmitted responsive to a user-input provided via the user-interface. The request for the recommended set of parameters can be transmitted responsive to an automatic detection of the acoustic environment. A plurality of features identifying characteristics of (i) the user and (ii) the acoustic environment may be identified. The adjusted set of parameters can be provided for use in determining another recommended set of parameters. The adjusted set of parameters can be stored as a portion of a plurality of data items representing parameters used by a plurality of users in different acoustic environments.

In another aspect, this document features a computer-implemented method that includes receiving, at one or more processing devices, identification information associated with (i) a user of a hearing assistance device and (ii) an acoustic environment of the hearing assistance device. The method also includes determining dynamically, based on the identification information, and using a plurality of pre-stored data items accessible to the one or more processing devices, a recommended set of parameters for adjusting settings of the hearing assistance device in the acoustic environment. The plurality of pre-stored data items represent parameters used by a plurality of users in different acoustic environments. The method further includes providing the recommended set of parameters to the hearing assistance device.

In another aspect, this document features a computer-implemented method that includes receiving, at one or more processing devices, first information representing a set of parameters that are usable to adjust a hearing assistance device. The method also includes receiving, at the one or more processing devices, second information identifying characteristics of (i) a user of the hearing device, and (ii) an acoustic environment. The method further includes processing the first and second information to update a database of a plurality of data items, wherein the database represents user-selected parameters of corresponding hearing devices in various acoustic environments, and storing a representation of the updated database in a storage device.

In another aspect, this document features a system that includes a recommendation engine and a storage device. The recommendation engine includes one or more processors and is configured to receive identification information associated with (i) a user of a hearing assistance device and (ii) an acoustic environment of the hearing assistance device. The recommendation engine is also configured to determine dynamically, based on the identification information, and using information in a plurality of pre-stored data items, a recommended set of parameters for adjusting settings of the hearing assistance device in the acoustic environment. The plurality of pre-stored data items represents parameters used by a plurality of users in different acoustic environments. The recommendation engine is further configured to provide the recommended set of parameters to the hearing assistance device. The storage device is configured to store the plurality of pre-stored data items.

In another aspect, this document features a system that includes a recommendation engine and a storage device. The recommendation engine includes one or more processing devices and is configured to receive first information representing a set of parameters that are usable to adjust a hearing assistance device. The recommendation engine also receives second information identifying characteristics of (i) a user of the hearing device, and (ii) an acoustic environment. The recommendation engine is further configured to process the first and second information to update a plurality of data items, wherein the plurality of data items represents user-selected parameters of corresponding hearing devices in various acoustic environments. The storage device configured to store a representation of the updated plurality of data items.

In another aspect, this document features one or more machine-readable storage devices having encoded thereon computer readable instructions for causing one or more processors to perform various operations. The operations include receiving identification information associated with (i) a user of a hearing assistance device and (ii) an acoustic environment of the hearing assistance device. The operations also include determining dynamically, based on the identification information, and using a plurality of pre-stored data items accessible to the one or more processing devices, a recommended set of parameters for adjusting settings of the hearing assistance device in the acoustic environment. The plurality of pre-stored data items represent parameters used by a plurality of users in different acoustic environments. The operations further include providing the recommended set of parameters to the hearing assistance device.

In another aspect, this document features one or more machine-readable storage devices having encoded thereon computer readable instructions for causing one or more processors to perform various operations. The operations include receiving first information representing a set of parameters that are usable to adjust a hearing assistance device. The operations also include receiving, at the one or more processing devices, second information identifying characteristics of (i) a user of the hearing device, and (ii) an acoustic environment. The operations further include processing the first and second information to update a database of a plurality of data items, wherein the database represents user-selected parameters of corresponding hearing devices in various acoustic environments, and storing a representation of the updated database in a storage device.

Implementations of the above aspects can include one or more of the following.

The recommended set of parameters can represent settings of the hearing assistance device that are based on attributes of the user and on the acoustic environment. Determining the recommended set of parameters includes identifying, based on the identification information, a user-type associated with the user, identifying, based on the identification information, an environment-type associated with the acoustic environment, and determining, based on the plurality of pre-stored data items, the recommended set of parameters corresponding to the user-type and the environment-type. The identification information can include one or more of: an identification of the particular hearing assistance device, demographic information, age information, or gender information. The identification information can also include one or more of spectral, temporal, or spectro-temporal features associated with the acoustic environment. The identification information associated with the acoustic environment can include information identifying a presence of one or more acoustic sources of a predetermined type. The identification information associated with the acoustic environment can include information on a number of talkers in the acoustic environment. The recommended set of parameters can be determined using a machine-learning process that is trained using the plurality of pre-stored data items. One or more identifying characteristics extracted from the identification information can be provided as an input to the trained machine learning process to obtain the recommended set of parameters. The communications between the one or more processing devices and the hearing assistance device can be routed through a mobile device.

Updating the database can further include determining a validity of the set of parameters. Updating the database can further include processing the second information to obtain a predetermined number of features associated with plurality of data items in the database. The second information can be processed to obtain a set of acoustic features. The second information can be processed to obtain a set of demographic features. The database can be updated based on one or more functions of the acoustic and demographic features.

Various implementations described herein may provide one or more of the following advantages.

Parameters for adjusting the settings of a hearing assistance device in a particular acoustic environment can be suggested based on a crowd-sourced model that takes into account parameters used by similar users in similar acoustic environments. By recommending parameters based on similar users and similar acoustic environments, the need for fine tuning complex parameters may be substantially reduced. This in turn allows a user to self-fit or fine-tune hearing assistance devices in different environments without visiting an audiologist or a technician.

Two or more of the features described in this disclosure, including those described in this summary section, may be combined to form implementations not specifically described herein.

The details of one or more implementations are set forth in the accompanying drawings and the description below. Other features, objects, and advantages will be apparent from the description and drawings, and from the claims.

### DESCRIPTION OF THE DRAWINGS

FIG. 1 is a diagram showing an example of an environment for providing recommended parameters to various hearing assistance devices.

FIG. 2 shows an example of a user interface for adjusting one or more parameters of a hearing assistance device.

FIG. 3 is a flowchart of an example process for providing a recommended set of parameters to a hearing assistance device.

FIG. 4 is a flowchart of an example process for updating a database of a plurality of data items used for providing recommended sets of parameters to hearing assistance devices.

FIG. 5 is a flowchart of an example process for providing a recommended set of parameters to a hearing assistance device.

FIG. 6 is a flowchart of an example process for providing an adjusted set of parameters to a hearing assistance device.

### DETAILED DESCRIPTION

Hearing assistance devices such as hearing aids and personal amplifiers may require adjustment of various parameters, particularly when a user of such a device moves from one acoustic environment to another. Such parameters can include, for example, parameters that adjust the dynamic range of a signal, gain, noise reduction parameters, and directionality parameters. In some cases, the parameters can be frequency-band specific. Selection of such parameters (often referred to as ‘fitting’ the device) can affect the usability of the device, as well as the user-experience. Manual fitting of hearing assistance devices, particularly for various types of acoustic environments can, however be expensive and time-consuming, often requiring multiple visits to a clinician's office. In addition, the process may depend on effective communications between the user and the clinician. For example, the user would have to provide feedback (e.g., verbal feedback) on the acoustic performance of the device, and the clinician would have to interpret the feedback to make adjustments to the parameter values accordingly. Apart from being time-consuming and expensive, the manual fitting process thus depends on a user's ability to provide feedback, and the clinician's ability to understand and interpret the feedback accurately.

Allowing the user to adjust the individual parameters of a hearing assistance device can also pose several challenges. For example, the number of parameters can be large, as well as technically esoteric, and can confuse the user. This can lead to potentially incorrect parameters that may also adversely affect the performance of the device and/or the hearing of the user.

The technology described in this document can be used to provide a set of recommended parameters for a hearing assistance device, wherein the parameters are selected based on historical data of user behavior in similar environments. For example, the recommended parameters can be based on parameters previously used or preferred by similar users in similar acoustic environments. The technology therefore harnesses information from historical user behavior data to provide recommendations for a given user in a given environment. The technology also provides a user interface that may allow a user to fine tune the recommended parameters based on personal preferences. The interface can provide a limited number of controls such that the user may adjust the recommended parameters without having to adjust a large number of parameters individually.

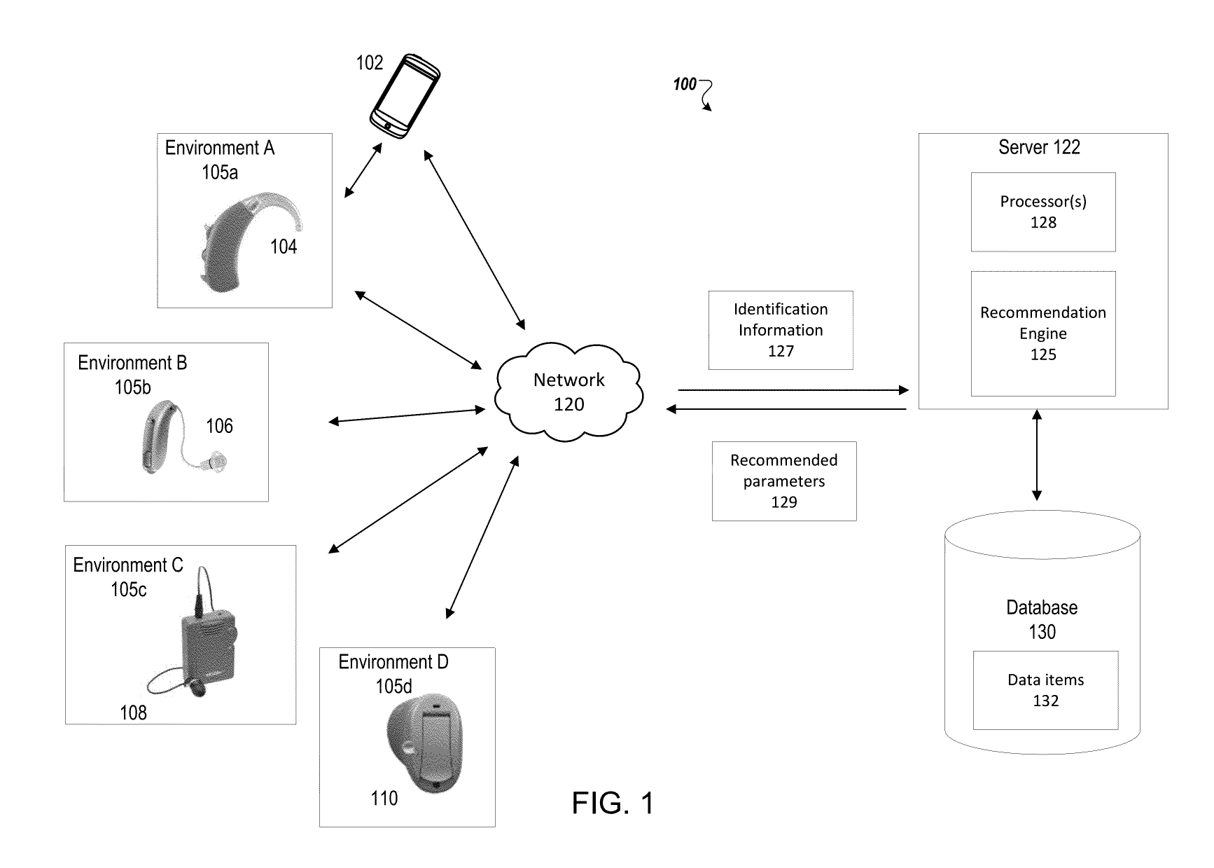

FIG. 1 shows an example environment 100 for providing recommended parameters to various hearing assistance devices. Examples of the hearing assistance devices include behind the ear (BTE) hearing aids 104, open-fit hearing aids 106, personal amplifiers 108, and completely-in-the canal (CIC) or invisible-in-the-canal (IIC) hearings aids 110. One or more of the hearing assistance devices can be configured to communicate, for example, over a network 120, with a remote computing device such as a server 122. The server 122 includes one or more processors or processing devices 128. In some implementations, communications between the hearing assistance device and the server 122 may be through a handheld device 102. Examples of the handheld device 102 can include, for example, a smartphone, tablet, e-reader, or a media playing device. In implementations where the communication between a hearing assistance device and the server 122 is routed through a handheld device 102, the handheld device 102 can be configured to execute an application that facilitates communications with the hearing assistance device.

The operating parameters of the various hearing assistance devices are adjusted in accordance with the hearing disability of the corresponding users. For example, at a broad level, the operating parameters of a hearing assistance device can be selected, for example, based on an audiogram for the corresponding user. The audiogram may represent, for example, the quietest sound that that the user can hear as a function of frequency. In some implementations, the operating parameters for a hearing assistance device can be derived from an audiogram, for example, using processes that provide such parameters as a function of one or more characteristics of the audiogram. Examples of such processes include NAL-NL1 and NAL-NL2, developed by National Acoustic Laboratories, Australia. Of these, the NAL-NL2 is designed to optimize speech intelligibility index while constraining loudness to not exceed the comparable loudness in an individual with normal hearing. Another example of such a process is the Desired Sensation Level (DSL) v5.0 which is designed to optimize audibility of the speech spectrum. These processes can provide various parameter values including, for example, target gains across the frequency spectrum for a variety of input levels, as well as frequency-specific parameters for compressors and limiters.

The operating parameters obtained based on the audiogram can then be fine-tuned in accordance with preferences of the user. This can include, for example, the user wearing the hearing assistance device and listening to a wide variety of natural sounds. In situations where a clinician such as an audiologist is involved, the user may describe his/her concerns about the sound quality (e.g., “it sounds too tinny”), and the clinician may make an adjustment to the device based on the feedback. This process can be referred to as “fitting” of the hearing assistance device, and may require multiple visits to the clinician.

In some implementations, the fitting process can be simplified by automating the selection of the operating parameters, at least partially, by using a recommendation engine 125 configured to provide a set of recommended parameters 129 based, for example, on a plurality of data items 132 that represent historical usage data collected from users of hearing assistance devices. The recommendation engine 125 can be implemented, for example, using one or more computer program products on one or more processing devices 128. The recommendation engine 125 can also be configured to dynamically update the operating parameters for a hearing assistance device as the device moves from one acoustic environment to another. In FIG. 1, the acoustic environments for the devices 104, 106, 108, and 110 are referred to as 105a, 105b, 105c, and 105d, respectively (and 105 in general). The acoustic environments 105 can differ significantly from one another, and the operating parameters for a hearing assistance device may need to be updated as the device moves from one acoustic environment to another. For example, a user may move from a concert hall (having, for example, loud acoustic sources) to a restaurant (having multiple relatively less loud acoustic sources (e.g., multiple talkers)), and the operating parameters of the hearing device may have to be updated accordingly. In some implementations, the recommendation engine 125 can be configured to facilitate such dynamic updates based on historical data represented in the plurality of data items 132.

The plurality of data items 132 can be used for supporting collaborative recommendations (sometimes referred to as ‘crowd-sourced’ recommendations, or collaborative filtering) for operating parameters of hearing assistance devices. The plurality of data items 132 can include, for example, historical data from a community of similar users, which can be used for predicting a set of parameters a given user is likely to prefer.

In some implementations, in order to provide the recommended set of parameters 129, the recommendation engine identifies a user type and an acoustic environment type for a current user from the identification information 127 received from a corresponding hearing assistance device. The identification information can include information indicative of the user type and/or the acoustic environment type associated with the current user. For example, the identification information 127 can include one or more identifiers associated with the user, (e.g., an identification of the particular hearing assistance device, demographic information associated with the user, age information about the user, or gender information about the user) and/or one or more identifiers associated with the corresponding acoustic environment, such as various spectral, temporal, or spectro-temporal features or characteristics (e.g., overall sound pressure level, variation in sound pressure level over time, sound pressure level in N frequency bands (N being an integer), variation of level in each band over time, the estimated signal-to-noise ratio, the frequency spectrum, the amplitude modulation spectrum, outputs of auditory model, and mel-frequency cepstral coefficients).

The plurality of data items 132 can be pre-stored on a storage device possibly as a part of a database 130 accessible to the recommendation engine 125. Even though FIG. 1 depicts the recommendation engine 125 as a part of the server 122, in some implementations, at least a portion of the recommendation engine can reside on a user device such as a handheld device 102. In some implementations, at least a portion of the plurality of data items 132 may also be stored on a storage device on the handheld device 102, or on a storage device accessible from the handheld device 102.

In some implementations, the plurality of data items can include a collection of linked datasets (also referred to as ‘snapshots’) representing historical user behavior. A linked dataset or snapshot can include, for example, a set of parameter values selected by a user for a hearing assistance device under a particular acoustical context (i.e., in a particular acoustic environment) at a given time. Each snapshot can be tied to a user, a device (or set of devices), and a timestamp. In some implementations, at least a portion of the recommendation engine 125 may perform operations of the process for creating and/or updating the plurality of data items 132.

The snapshots or linked datasets can be collected in various ways. In some implementations, the snapshots can be obtained at predetermined intervals (e.g., using a repeating timer) and/or by identifying patterns in users' behavior. For example, a snapshot can be taken upon determining that a user is satisfied with the sound quality delivered by the hearing assistance device. The determination can be made, for example, based on determining that the user has not changed the parameters for a threshold amount of time. In some implementations, a user may be able to modify parameters of a hearing assistance device using controls displayed in an application executing on a handheld device 102. In such cases, if the user does not change positions of the controls for more than a threshold period (e.g., a minute), a determination may be made that the user is satisfied with the sound quality, and accordingly, a snapshot of the corresponding parameters and acoustic environment can be obtained and stored. In implementations where the parameters of the hearing assistance device are controlled using an application on a handheld device, a particular set of parameters can be represented and/or stored as a function of controller positions in the application. The controller positions in the application may be referred to as a corresponding “application state.”

In some implementations, the collected snapshots are stored as a part of the plurality of data items 132 linked to both the acoustical context (e.g., features of the corresponding acoustic environment) as well as the application state. In some implementations, the acoustic context or environment can be represented using various spectral, temporal, or spectro-temporal statistics, including, for example, overall sound pressure level, variation in sound pressure level over time, sound pressure level in N frequency bands (N being an integer), variation of level in one or more of the N bands over time, the estimated signal-to-noise ratio (SNR), the frequency spectrum, the amplitude modulation spectrum, cross-frequency amplitude envelope correlations, cross-modulation-frequency amplitude envelope correlations, outputs of an auditory model, and mel-frequency cepstral coefficients. The SNR can be estimated, for example, from the variations in the measured signal by attributing peaks to signals of interest and attributing valleys to noise. Features of the acoustic environment can also include estimated meta-data such as a number of talkers, gender of talkers, presence of music, genre of music, etc. In some implementations, an application state can represent corresponding digital signal processing parameter values of the hearing assistance device(s), the details about the devices (device ID, device type, etc.), location of use (e.g., the restaurant at the crossing of Third Street and 23^{rd} Avenue), time of use (e.g., 7:30 PM on a Saturday), and the duration for which the application state remains unchanged. In some implementations, the collected snapshots can be referenced to a user account such that various information about corresponding user can be linked to the snapshot. Examples of such user information include age, gender, self-reported hearing level, measured hearing level, etiology of hearing loss, and location.

In some implementations, a snapshot is obtained by a handheld device such as the device executing the application for controlling the hearing assistance device. The collected snapshots can be stored on, or shared with, a variety of devices. In some implementations, a snapshot can be stored locally on the user's handheld device (e.g. smartphone, tablet, or watch). The snapshot may also be transmitted to the remote server 122 (e.g., over the network 120) for storing as a part of the database 130. In some implementations, the snapshot can also be stored on the user's hearing assistance device.

In some implementations, the recommendation engine 125 may check if a snapshot validly represents a usable set of data. The check can result in some snapshots being discarded as being invalid. For example, snapshots from a user who does not use a hearing assistance device often (as compared to users who use them, for example, at least for a threshold period of time every day) may be discarded when recommending parameters for a regular user. Snapshots that represent outlier controller settings for one or more parameters, or separate adjustments for the two ears may also be discarded.

In some implementations, the collected snapshots can be preprocessed by the recommendation engine 125. For example, the complete set of acoustic features in the snapshots can be subjected to a dimension reduction process (e.g., a principal components analysis (PCA), or independent component analysis (ICA)) to represent the snapshots using a smaller number of independent features. In some implementations, the same dimension reduction process can be repeated for the demographic information about the individual users included in the snapshots. Dimension reduction refers to machine learning or statistical techniques in which a number of datasets, each specified in high-dimensional space, is transformed to a space of fewer dimensions. The transformation can be linear or nonlinear, and can include, for example, principal components analysis, factor analysis, multidimensional scaling, artificial neural networks (with fewer output than input nodes), self-organizing maps, and k-means cluster analysis.

Various possible interactions between acoustic and demographic components can also be computed, for example, as a function of one or more of the identifying features representing such components. For example, to capture differences between how people of different age but with the same level of hearing loss react to the same SNR level, a composite variable that is a product of age, hearing loss level and SNR, can be computed. In some implementations, other composite functions of the acoustic and demographic components (e.g., logarithm, exponential, polynomial, or another function) can also be computed. Therefore, a preprocessed snapshot entry can include one or more of an array of acoustic component scores, demographic component scores, and/or scores that are functions of one or more acoustic and/or demographic components.

Once the recommendation engine identifies one or more characteristics associated with a current user and/or the current user's acoustic environment, the recommendation engine processes the plurality of data items 132 based on the identified the characteristics and provides relevant recommended parameters 129. For example, the recommendation engine 125 can be configured to determine, based on the identification information 127, a user-type associated with the current user and/or an environment-type associated with the corresponding acoustic environment, and then provide the recommended parameters 129 relevant for the identified user-type and/or environment-type.

The recommendation engine may process the plurality of data items 132 in various ways to determine the recommended parameters 129. In some implementations, the recommendation engine 125 determines, based on the plurality of data items 132, a set of relevant snapshots that correspond to users and/or environments that are substantially similar to the current user and/or the current user's acoustic environment, respectively. The recommended parameters 129 can then be calculated based combining the relevant snapshots in a weighted combination. In assigning the weights, snapshots that are more similar to the current user/environment are assigned a higher weight in computing the recommended parameters 129.

The similarity between a stored pair of snapshots (or between a stored snapshot and a snapshot for a current user) can be computed, for example, based on a similarity metric calculated from the corresponding common identifying features or characteristics of the snapshot. For example, if each of the snapshots include values corresponding to acoustic features A, B, and C, a similarity metric can be calculated based on the corresponding values. Examples of such similarity metrics can include, for example, a sum of absolute differences (SAD), a sum of squared differences (SSD), or a correlation coefficient. In some implementations, the similarity can be determined based on other identifying features in the snapshots. For example, two snapshots can be determined to be similar if both correspond to male users, users in a particular age range, or users with a particular type of hearing loss. In some implementations, calculating the similarity metric can include combining one or more of the identifying features in a weighted combination. For example, the identifying feature representing the type of hearing loss can be assigned a higher weight than the identifying feature representing gender in computing similarity between snapshots.

In some implementations, the recommendation engine 125 selects the relevant snapshots based on a similarity metric computed with respect to a snapshot corresponding to the current user. For example, the recommendation engine can be configured to calculate similarity metrics between a snapshot from the current user and snapshots stored within the plurality of data items 132, and then select as relevant snapshots the ones for which the corresponding similarity metric values exceed a threshold. For example, if the similarity metric range is between 0 and 1 (with 0 representing no similarity, and 1 representing a perfect match), the recommendation engine 125 can be configured to choose as relevant snapshots, for example, the ones that produce a similarity metric value of 0.8 or higher.

In some implementations, the relevant snapshots can include snapshots generated by the current user, as well as snapshots generated by other users. In some implementations, the relevant snapshots include snapshots only from users determined to be similar to the user for who the recommended parameters 129 are being generated. In some implementations, the relevant snapshots can include only ‘archetypal’ snapshots representing a user-type or population of similar users in similar environments. Such archetypal snapshots can be generated, for example, by combining multiple snapshots determined to be similar to one another based on a similarity metric.

In some implementations, the relevant snapshots can be obtained by downloading at least a portion of the plurality of data items 132 from a remote database 130 or a remote server 122. For example, the relevant snapshots can be downloaded to a handheld device 102 controlling a hearing assistance device, or to the hearing assistance device. In some implementations, the relevant snapshots can be obtained by a remote server 122 from a database 130 accessible to the server 122. In some implementations, the relevant snapshots can be selected from snapshots saved within a database stored at a local storage location.

The relevant snapshots can then be combined in a weighted combination to determine the recommended parameters 129. In some implementations, combining the relevant snapshots in a weighted combination can include assigning a particular weight to each of the parameters included in a given snapshot. The particular weight for a given snapshot can be assigned based on, for example, the value of the similarity metric computed for the given snapshot. In the example where the relevant snapshots are chosen based on the similarity metric being higher than 0.8, a snapshot yielding a similarity metric value of 0.9 can be assigned a higher weight than a snapshot yielding a similarity metric value of 0.82. Once weights are assigned to relevant snapshots, the corresponding parameter values from the snapshots can be combined in a weighted combination using such assigned weights to provide the corresponding recommended parameter 129. In some implementations, the weights can also be determined based on a machine learning process that is trained to determine a mapping between the weights and the similarity. In some implementations, the relevant snapshots can also be assigned equal weights. In such cases, the corresponding parameters from different relevant snapshots can be averaged to compute the corresponding recommended parameter. In some implementations, because a user is likely to re-use parameters used in the past, snapshots from the current user may be assigned a high weight in determining the recommended parameters. In some implementations, relative weightings of user similarity and acoustic environment similarity may be determined empirically.

The recommendation engine 125 may consider various other factors in assigning weights to the relevant snapshots. Such factors can include, for example, duration of use of a given set of digital signal processing parameter values. For example, if a hearing assistance device is used for a long time using parameters corresponding to a particular snapshot, such a snapshot can be assigned a high weight in determining the recommended parameters 129. Another example of such a factor can be location proximity, where snapshots that were obtained near the current location are assigned higher weights as compared to snapshots obtained further away from the current location.

In some implementations, the recommendation engine 125 can compute the recommended parameters 129 as a weighted combination of digital signal processing parameters, or controller positions corresponding to the relevant snapshots. In some implementations, a controller position corresponding to a snapshot can map to multiple digital signal processing parameter values. The weighted combination can be of various types, including, for example, a weighted average, a center of mass, or a centroid.

In some implementations, the recommendation engine 125 can be configured to use a machine learning process for predicting the recommended parameters for a given acoustic environment based on historical parameter usage data in various acoustic environments, as represented in the database of plurality of data items 132 (or snapshots). This can be done for example by identifying a set of independent variables (or predictor variables) in the snapshots, and a set of parameters or dependent variables that depend on the independent variables. Examples of the independent variables include demographic information about the user (e.g., age, gender, hearing loss type, etc.) and/or acoustic characteristics of the environment (e.g., various spectral, temporal, or spectro-temporal statistics, including, for example, overall sound pressure level, variation in sound pressure level over time, sound pressure level in N frequency bands (N being an integer), variation of level in each one or more of the N bands over time, the estimated signal-to-noise ratio, the frequency spectrum, the amplitude modulation spectrum, cross-frequency envelope correlations, cross-modulation-frequency envelope correlations, outputs of an auditory model, and mel-frequency cepstral coefficients). Examples of the dependent variables include various operating parameters of the hearing assistance devices (e.g., low-frequency gain, high frequency gain, or position of a controller that maps to one or more parameters for a corresponding hearing assistance device).

The machine learning process can be trained using the plurality of data items 132 as training data such that the machine learning process determines a relationship between the independent and dependent variables. Once the machine learning process is trained, the process can be used for predicting the recommended parameters 129 from a set of independent variables identified by the recommendation engine 125 from the identification information 127. In one illustrative example, if the recommendation engine uses linear regression as the machine learning process, the following relationship between the independent and dependent variables may be derived from the snapshots represented in the plurality of data items 132:

yᵢ=β₀+β₁xᵢ₁+β₂xᵢ₂+ . . . βₚxᵢₚ

Where i indexes the snapshot number, y represents the target signal processing parameter (dependent variable), x₁, x₂, . . . , xₙ represent each of p predictor variables (independent variables) and β₁, β₂, . . . , βₙ represent the coefficients applied to the corresponding independent variables. Once such a relationship is determined by the recommendation engine 125, a target parameter (in the set of recommended parameters 129) can be computed as a function of the independent variables identified from a snapshot corresponding to a current user.

Various machine learning processes can be used by the recommendation engine 125 in determining the recommended parameters 129. For example, one or more machine learning techniques such as linear regression, deep neural networks, naïve Bayes classifiers, and support vector machines may be used to determine a relationship between the predictor variables and the dependent variables. In some implementations, the machine learning processes used in the recommendation engine 125 can be selected, for example, empirically, based on usability of predicted sets of recommended parameters as reported by users.

The machine learning process can be trained in various ways. In some implementations, the various snapshots represent the plurality of data items 132 are separately used as data points in training the machine learning process. In some implementations, various archetypal environments (also referred to as representative environment-types) can be determined from the snapshots and the machine learning process can be trained using such archetypal environments. Such archetypal environments can be generated, for example, by combining (e.g. averaging) individual environments that cluster together based on one or more characteristics of the acoustic environments. When a machine learning process trained in this manner is used, the recommendation engine 125 can be configured to classify the current user's snapshot as one of the archetypal environment based on information extracted from the identification information.

In some implementations, because a user is likely to re-use parameters used by him/her in the past, a machine learning process can be configured to assign higher weights to snapshots from the same user. This can be done for example, using a large number of previous snapshots from the user (or a large number of duplications of those snapshots) in training the machine learning process. In some implementations, two separate machine learning processes can be used: one trained based on snapshots from the same user (or multiple users from a predetermined user type), and the other trained based on snapshots from other users. In determining the final recommended parameters, the corresponding parameters obtained using the two separate machine learning processes can be combined as a weighted combination, and the parameter from the machine learning process trained using the snapshots from the same user can be assigned a higher weight in such a combination.

The recommended parameters 129 (which can be represented as an array of digital signal processing parameters) can be provided to the hearing assistance device of the current user in various ways. In some implementations, where the recommendation engine resides on the server 122, the recommended parameters 129 can be provided over the network 120 to the user's hearing assistance device. In some implementations, the recommended parameters 129 can be provided to a handheld device 102 that communicates with and controls the user's hearing assistance device. In some implementations, where the recommended parameters 129 are determined on a controlling handheld device 102, the parameters can be provided to the hearing assistance device over a wired or wireless connection. In some implementations, where the recommended parameters 129 are determined on a hearing assistance device, the determined parameters are provided to a controller module (e.g., a processor, microcontroller, or digital signal processor (DSP)) that controls the operating parameters for the hearing assistance device.

The recommendation engine 125 can be configured to compute the recommended parameters 129 in various ways, depending on amount of information available for the current user. For example, when various information about the user is known, the recommended parameters 129 can be personalized for the user to a high degree. However, when information about the user is limited, an initial set of recommended parameters 129 can be provided based on snapshots from broadly similar users (e.g., users with similar demographic characteristics such as age, gender, or hearing status). In some implementations, the initial set of recommended parameters 129 can be provided based on input obtained from the user. For example, the current user can be asked to input preferred parameters for a set of example acoustic environments. The example acoustic environments can include actual acoustic environments (e.g., if a user is instructed to go to a loud restaurant) or simulated acoustic environments (e.g., if the user is instructed to identify preferred parameters while listening to a recording or simulation of a loud restaurant). In some implementations, the obtained user input can be used by the recommendation engine 125 to create initial snapshots which are then used in computing the recommended parameters 129.

The technology described herein can also facilitate various types of user interaction with the recommendation engine. The interactions can be facilitated, for example, by a user interface provided via an application that executes on a handheld device 102 configured to communicate with both the corresponding hearing assistance device, as well as the recommendation engine 125. In some implementations, a user can fine-tune received recommendation parameters 129 via such an interface to further personalize the experience of using the hearing assistance device. The user can also use the interface to set parameters for the hearing assistance device in the absence of any recommended parameters 129.

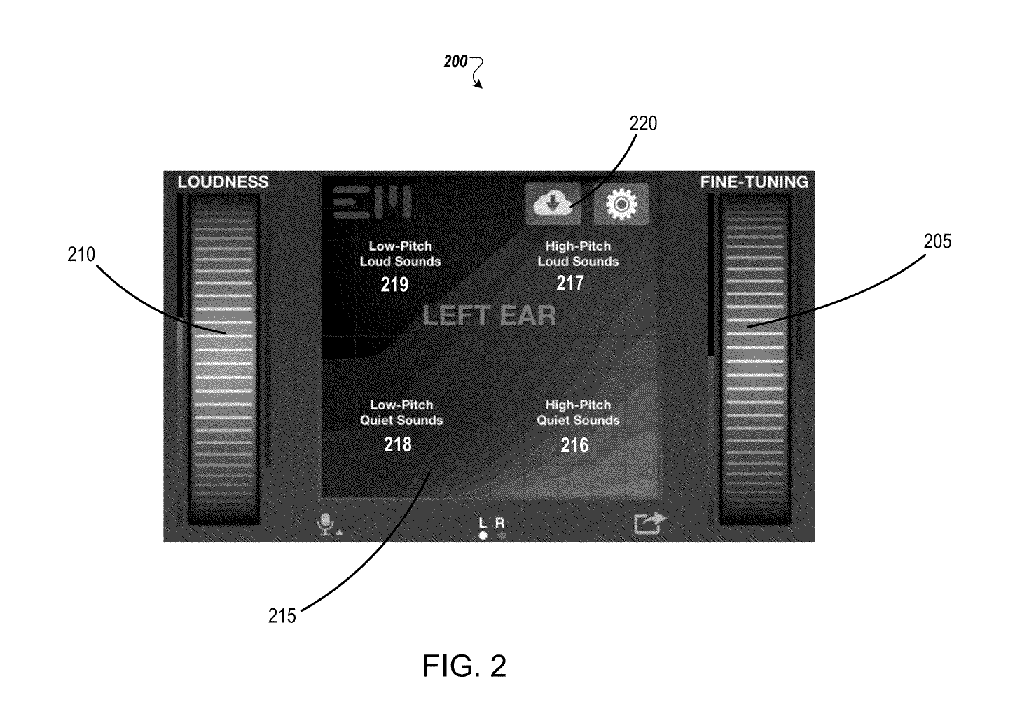

An example of a user interface 200 is shown in FIG. 2. The interface 200 can include, for example, a control 205 for selecting frequency ranges at which amplification is needed, and a control 210 for adjusting the gain for the selected frequency ranges. On a touch screen display device, the controls 205 and 210 represents scroll-wheels that can be scrolled up or down to select desired settings. Other types of controls, including, for example, selectable buttons, fillable forms, text boxes, etc. may also be used. In some implementations, each combination of the positions of the controls 205 and 210 maps on to a particular set of parameters for the hearing assistance device. In such cases, the controls 205 and 210 allow a user to effectively control a larger number of parameters of the hearing assistance device without having to encounter the complexity of adjusting individual parameters individually.

In some implementations, the interface 200 can also include a visualization window 215 that graphically represents how the adjustments made using the controls 205 and 210 affect the processing of the input signals. For example, the visualization window 215 can represent (e.g., in a color coded fashion, or via another representation) the effect of the processing on various types of sounds, including, for example, low-pitch loud sounds, high-pitch loud sounds, low-pitch quiet sounds, and high-pitch quiet sounds. The visualization window 215 can be configured to vary dynamically as the user makes adjustments using the controls 205 and 210, thereby providing the user with real-time visual feedback on how the changes would affect the processing. In the particular example shown in FIG. 2, the shades in the quadrant 216 of visualization window 215 shows that the selected parameters would amplify the high-pitch quiet sounds the most. The shades in the quadrants 217 and 218 indicate that the amplification of the high-pitch loud sounds and low-pitch quiet sounds, respectively, would be less as compared to the sounds represented in the quadrant 216. The absence of any shade in the quadrant 219 indicates that the low-pitch loud sounds would be amplified the least. Such real time visual feedback allows the user to select the parameters not only based on what sounds better, but also on prior knowledge of the nature of the hearing loss. In some implementations, the visualization window can also be configured to represent how the adjustments made using the controls 205 and 210 affect various other parameters of the corresponding hearing assistance device.

The interface 200 can be configured based on a desired amount of details and functionalities. In some implementations, the interface 200 can include a control 220 for saving the selected parameters and/or providing the selected parameters to a remote device such as a server 122 or a remote storage device. Separate configurability for each ear can also be provided. In some implementations, the interface 200 can allow a user to input information based on an audiogram such that the parameters can be automatically adjusted based on the nature of the audiogram. For example, if the audiogram indicates that the user has moderate to severe hearing loss at high frequencies, but only mild to moderate loss at low frequencies, the parameters can be automatically adjusted to provide the required compensation accordingly. In some implementations, where the initial device is equipped with a camera (e.g., if the initial device is a smartphone), the interface 200 can provide a control for capturing an image of an audiogram from which the parameters can be determined.

In some implementations, the interface 200 can be configured to allow a user to request recommended parameters 129. In some implementations, such a request may also be sent by pressing a button on the hearing assistance device. In some implementations, the hearing assistance device (or the handheld device that controls the hearing assistance device) may automatically initiate a recommendation request when a change in acoustic environments is detected. This can allow, for example, the hearing device to automatically adapt to changing acoustic environments. For example, if some threshold value of acoustic similarity between environments is exceeded, a recommendation can be initiated automatically. Such a change can also occur if the difference between the current GPS location and that of the last recommendation exceeds a threshold value. In some implementations, the thresholds can be pre-defined or set by the user.

In some implementations, when the hearing assistance device (or the handheld device 102 that controls the hearing assistance device) detects a change in environment (acoustic or location) and obtains a set of recommended parameters, the interface 200 can be configured to notify the user of the availability of the recommended parameters. The interface 200 can also allow the user to either accept or reject the recommended parameters. In some implementations, the interface 200 may also allow a user to ‘undo’ the effects of a set of recommended parameters by reverting to a preceding set of parameter values.

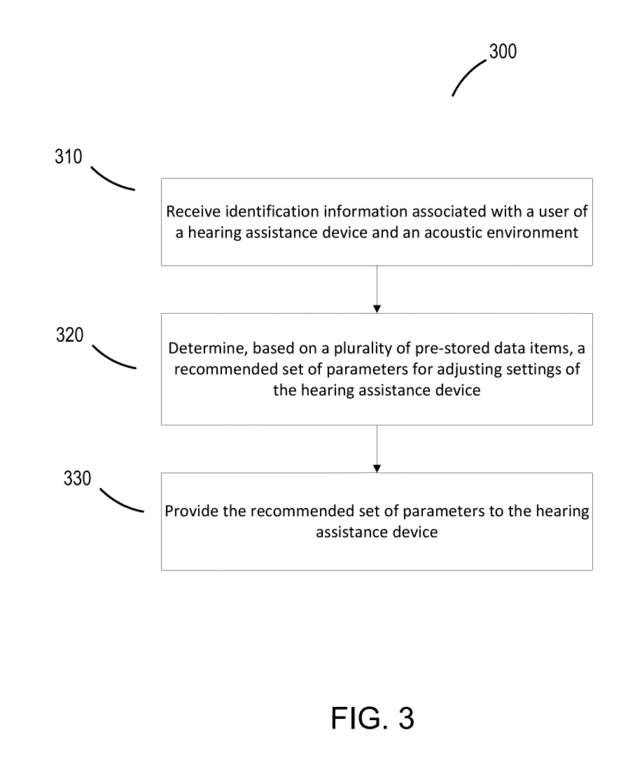

FIG. 3 shows a flowchart of an example process 300 for providing a recommended set of parameters to a hearing assistance device. The operations of the process 300 can be performed on one or more of the devices described above with respect to FIG. 1. In some implementations, at least a portion of the process 300 can be performed by the recommendation engine 125, which can be implemented on a server 122. Portions of the process 300 can also be performed on a handheld device 102, or a hearing assistance device.

The operations of the process 300 include receiving identification information associated with a user of a hearing assistance device and an acoustic environment of the acoustic device (310). The hearing assistance device and the corresponding acoustic environment can be substantially similar to those described above with reference to FIG. 1. The identification information associated with the hearing assistance device can include, for example, one or more of: an identification of the particular hearing assistance device, demographic information associated with the user, age information about the user, or gender information about the user. Identification information associated with the acoustic environment can include, for example, various spectral, temporal, or spectro-temporal statistics, including, for example, overall sound pressure level, variation in sound pressure level over time, sound pressure level in N frequency bands, variation of level in each band over time, the estimated signal-to-noise ratio, the frequency spectrum, the amplitude modulation spectrum, cross-frequency envelope correlations, cross-modulation-frequency envelope correlations, outputs of an auditory model, and/or mel-frequency cepstral coefficients. The identification information associated with the acoustic environment can also include information identifying a presence of one or more acoustic sources of interest (e.g., human speakers), or acoustic sources of a predetermined type (e.g., background music).

The operations of the process 300 also includes determining, based on a plurality of data items, a recommended set of parameters for adjusting parameters of the hearing assistance device in the acoustic environment (320). The dynamic determination can be made, for example, based on the identification information, and the plurality of data items can be based on parameters used by various other users in different acoustic environments. The recommended set of parameters can represent settings of the hearing assistance device computed based on the attributes of the user as well as the acoustic environment of the user.

In some implementations, determining the recommended set of parameters can include, identifying a user-type associated with the user, and an environment-type associated with the acoustic environment. Such identifications can be made, for example, based on the identification information received from the corresponding hearing device. The recommended set of parameters corresponding to the user-type and the environment-type can then be determined based on the plurality of data items. In some implementations, this can include selecting a plurality of relevant snapshots from the snapshots represented in the plurality of data items, and then determining recommended parameters by combining corresponding parameters from the relevant snapshots in a weighted combination. In some implementations, the recommended set of parameters can be determined, for example, based on a machine learning process (e.g., a regression analysis).

The operations of the process further includes providing the recommended set of parameters to the hearing assistance device (330). In some implementations, such communications between the recommendation engine and the hearing assistance device can be routed through a handheld device such as a smart phone or tablet.

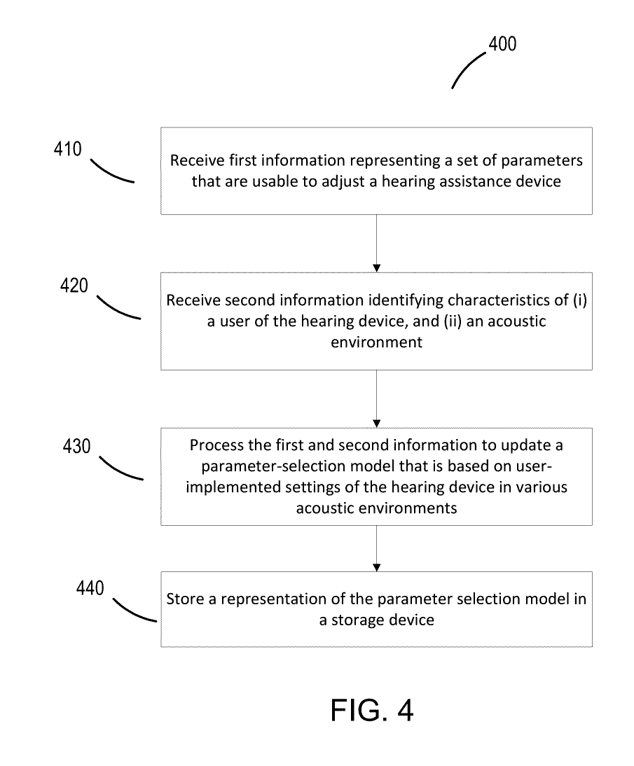

FIG. 4 is a flowchart of an example process 400 for updating a database of a plurality of data items used for providing recommended sets of parameters to hearing assistance devices. The operations of the process 400 can be performed on one or more of the devices described above with respect to FIG. 1. In some implementations, at least a portion of the process 400 can be performed by the recommendation engine 125, which can be implemented on a server 122. Portions of the process 400 can also be performed on a handheld device 102, or a hearing assistance device.

Operations of the process 400 includes receiving first information representing a set of parameters that are usable to adjust a hearing assistance device (410). In some implementations, the set of parameters can be received from a handheld device (e.g., the handheld device 102 described with reference to FIG. 1). The set of parameters can also be received from a hearing assistance device. Operations of the process 400 also includes receiving second information identifying characteristics of a user of the hearing device and an acoustic environment of the hearing device (420). In some implementations, the second information can include information substantially similar to the identification information described above with reference to FIG. 3.

The operations of the process 400 further include processing the first and second information to update the plurality of data items that are based on user implemented parameters of the hearing device in various acoustic environments (430). In some implementations, the first and second information together may represent a snapshot described above with reference to FIG. 1. In some implementations, the plurality of data items can be substantially similar to the data items 132 described above with reference to FIG. 1. In some implementations, updating the plurality of data items can include determining a validity of the received set of parameters. For example, if the received set of parameters are determined to be outliers, the set of parameters may not be used in updating the data items.

In some implementations, updating the plurality of data items can include processing the second information to obtain a predetermined number of features associated with the plurality of data items. This can include, for example, using a dimension reduction process to reduce the number of parameters in the second information from a first higher number to a second lower number that represents the number of features associated with the plurality of data items. The predetermined number of features can include, for example, one or more acoustic features and/or one or more demographic features associated with the user. In some implementations, the plurality of data items can be updated based on one or more functions of the acoustic and/or demographic features. The operations of the process 400 can also include storing a representation of the plurality of data items in a storage device (440). The storage device can reside on, or be accessible from, one or more of a server (e.g., the server 122 of FIG. 1), a handheld device (e.g., the device 102 of FIG. 1) and a hearing assistance device (e.g., the devices 104, 106, 108, and 110 of FIG. 1).

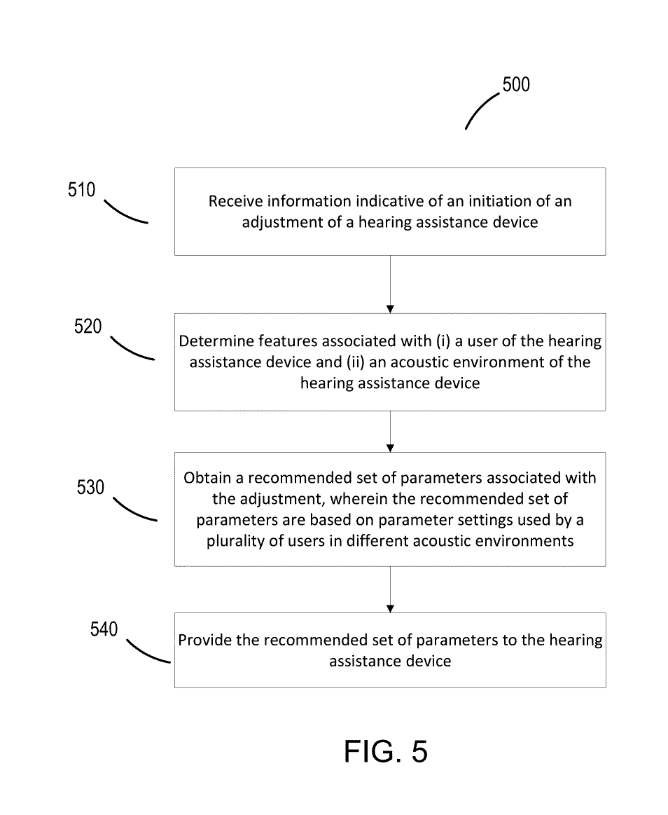

FIG. 5 is a flowchart of an example process 500 for providing a recommended set of parameters to a hearing assistance device. The operations of the process 500 can be performed on one or more of the devices described above with respect to FIG. 1. In some implementations, at least a portion of the process 500 can be performed by the recommendation engine 125, which can be implemented on a server 122. Portions of the process 500 can also be performed on a handheld device 102, or a hearing assistance device.

Operations of the process 500 include receiving information indicative of an initiation of an adjustment of a hearing assistance device (510). In some implementations, such information can be received based on user-input obtained via a user interface. For example, an application executing on a handheld device can provide a user interface (e.g., the user interface 200 of FIG. 2) that allows a user to request the adjustment via one or more controls provided within the user interface. In some implementations, the information indicative of the initiation can also be received from a hearing assistance device. For example, the initiation can be triggered by user-input received via a button or other control provided on the hearing assistance device. In some implementations, the initiation can be automatic, for example, based on detecting a change in the acoustic environment of the hearing assistance device. Such a change can be detected, for example, by processing circuitry residing on the hearing assistance device, or on a handheld device configured to communicate with the hearing assistance device.

Operations of the process 500 also include determining one or more features associated with (i) a user of the hearing assistance device and/or (ii) an acoustic environment of the hearing assistance device (530). In some implementations, the features can include information substantially similar to the identification information described above with reference to FIG. 3.

Operations of the process 500 also include obtaining a recommended set of parameters associated with the adjustment (530). The recommended set of parameters are based on parameters used by a plurality of users in different acoustic environments. In some implementations, the recommended set of parameters are obtained from a remote computing device. In such cases, obtaining the parameters includes providing one or more identifying features of the user and/or the acoustic environment to the remote computing device, and in response, receiving the recommended set of parameters from the remote computing device. In some implementations, the recommended set of parameters can also be obtained from local processing circuitry (e.g., a processor, microcontroller or DSP of the device that receives the initiation information in step 510).

Operations of the process further include providing the recommended set of parameters to the hearing assistance device (540). In some implementations, where the process 500 is executed on a handheld device that controls the hearing assistance device, the parameters can be provided to the handheld device via a wired or wireless connection. In implementations where the process 500 is executed on the hearing assistance device, the parameters are provided to circuitry that alters the operating parameters for the device.

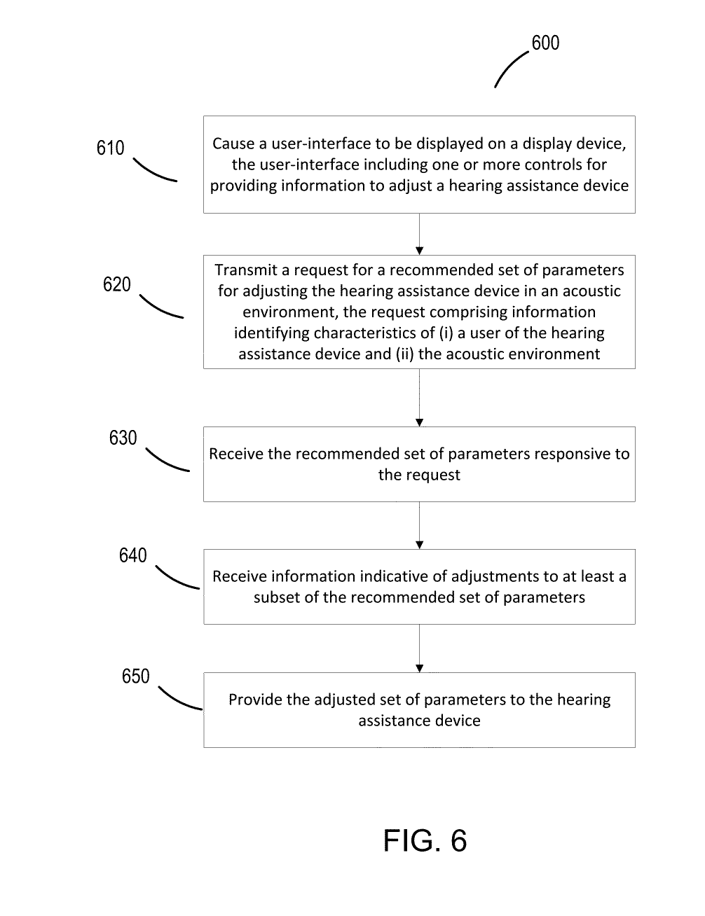

FIG. 6 is a flowchart of an example process 600 for providing an adjusted set of parameters to a hearing assistance device. The operations of the process 600 can be performed on one or more of the devices described above with respect to FIG. 1. In some implementations, at least a portion of the process 600 can be performed on a handheld device 102, or a display associated with a hearing assistance device.

Operations of the process 600 include causing a user-interface to be displayed on a display device (610). The user-interface can include one or more controls for providing information to adjust a hearing assistance device. In some implementations, the user-interface can be substantially similar to the user-interface 200 described with reference to FIG. 2. The operations of the process 600 include transmitting a request for a recommended set of parameters for adjusting the hearing assistance device in an acoustic environment (620). The request includes identification information associated with (i) a user of the hearing assistance device and/or (ii) the acoustic environment of the hearing assistance device. The request can be transmitted, for example, responsive to a user input for the request provided by the user-interface. The request can also be transmitted, for example, responsive to an automatic detection of the acoustic environment. In some implementations, the identification information can be substantially similar to the identification information 127 described above with reference to FIG. 1. In such cases, the process 600 can also include determining a plurality of features identifying characteristics of the user and the acoustic environment.

Operations of the process 600 also include receiving the recommended set of parameters from a remote computing device responsive to the request (630). For example, the recommended set of parameters can be received by a handheld device or hearing assistance device from a remote server in response to the handheld device or hearing assistance device providing the request to the server. The recommended set of parameters can be based on parameters used by a plurality of users in different acoustic environments. Such parameters can be obtained by accessing a plurality of data items substantially similar to the data items 132 described with reference to FIG. 1.

The operations of the process 600 can further include receiving information indicative of adjustments to at least a subset of the recommended set of parameters (640). Such adjustments can be received via one or more controls provided, for example, on the user-interface. In some implementations, the adjustments can be received by one or more hardware controls (e.g., scroll-wheels or buttons) provided on the hearing assistance device. In some implementations, the hardware or user-interface based controls allow a user to fine-tune settings represented by the recommended parameters to further personalize the acoustic experience provided by the hearing assistance device.

The operations of the process 600 also include providing the adjusted set of parameters to the hearing assistance device (650). In some implementations, where the process 600 is executed on a handheld device that controls the hearing assistance device, the parameters can be provided to the handheld device via a wired or wireless connection. In implementations where the process 600 is executed on the hearing assistance device, the parameters are provided to circuitry that alters the operating parameters for the device. In some implementations, the adjusted set of parameters can be stored as a snapshot that can be used in determining future recommendations. For example, the adjusted set of parameters can be stored as a part of a plurality of data items used in determining the recommended set of parameters. In such cases, the adjusted set of parameters can be provided to the storage device or computing device (e.g., a remote server) where the plurality of data items is stored.

The functionality described herein, or portions thereof, and its various modifications (hereinafter “the functions”) can be implemented, at least in part, via a computer program product, e.g., a computer program tangibly embodied in an information carrier, such as one or more non-transitory machine-readable media, for execution by, or to control the operation of, one or more data processing apparatus, e.g., a programmable processor, a computer, multiple computers, and/or programmable logic components.

A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a network.

Actions associated with implementing all or part of the functions can be performed by one or more programmable processors executing one or more computer programs to perform the functions of the calibration process. All or part of the functions can be implemented as, special purpose logic circuitry, e.g., an FPGA and/or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Components of a computer include a processor for executing instructions and one or more memory devices for storing instructions and data.

Other embodiments not specifically described herein are also within the scope of the following claims. Elements of different implementations described herein may be combined to form other embodiments not specifically set forth above. Elements may be left out of the structures described herein without adversely affecting their operation. Furthermore, various separate elements may be combined into one or more individual elements to perform the functions described herein.

What is claimed is:

1. A computer-implemented method comprising:
receiving, by one or more processing devices, information indicative of an initiation of an adjustment of a hearing assistance device;
determining, by the one or more processing devices, features associated with (i) a user of the hearing assistance device and (ii) an acoustic environment of the hearing assistance device;
obtaining, based on the features, a recommended set of parameters associated with the adjustment, wherein the recommended set of parameters are based on parameters used by a plurality of users in different acoustic environments; and
providing the recommended set of parameters to the hearing assistance device.

2. The method of claim 1, wherein the adjustment is initiated based on data representing a user-input obtained via a user-interface.

3. The method of claim 1, wherein the adjustment is automatically initiated based on a change in the acoustic environment for the hearing assistance device.

4. The method of claim 1, wherein obtaining the recommended set of parameters further comprises:
providing the features to a remote computing device; and
receiving the recommended set of parameters from the remote computing device in response to providing the features.

5. A computer-implemented method comprising:
causing, by one or more processing devices, a user-interface to be displayed on a display device, the user-interface including one or more controls for providing information to adjust a hearing assistance device;
transmitting a request for a recommended set of parameters for adjusting the hearing assistance device in an acoustic environment, the request comprising identification information associated with (i) a user of the hearing assistance device and (ii) the acoustic environment;
receiving, from a remote computing device, and responsive to the request, the recommended set of parameters;
receiving, via the one or more controls, information indicative of adjustments to at least a subset of the recommended set of parameters; and
providing the adjusted set of parameters to the hearing assistance device.

6. The method of claim 5, wherein the recommended set of parameters are based on parameters used by a plurality of users in different acoustic environments.

7. The method of claim 5, wherein the request for the recommended set of parameters is transmitted responsive to a user-input provided via the user-interface.

8. The method of claim 5, wherein the request for the recommended set of parameters is transmitted responsive to an automatic detection of the acoustic environment.

9. The method of claim 5 further comprising:
determining, by the one or more processing devices, a plurality of features identifying characteristics of (i) the user and (ii) the acoustic environment.

10. The method of claim 5, further comprising providing the adjusted set of parameters for use in determining another recommended set of parameters.

11. The method of claim 10, further comprising storing the adjusted set of parameters as a portion of a plurality of data items representing parameters used by a plurality of users in different acoustic environments.

12. A system comprising:
memory; and
one or more processing devices configured to:
receive information indicative of an initiation of an adjustment of a hearing assistance device,
determine features associated with (i) a user of the hearing assistance device and (ii) an acoustic environment of the hearing assistance device,
obtain, based on the features, a recommended set of parameters associated with the adjustment, wherein the recommended set of parameters are based on parameters used by a plurality of users in different acoustic environments, and
provide the recommended set of parameters to the hearing assistance device.

13. The system of claim 12, wherein the adjustment is initiated based on data representing a user-input obtained via a user-interface.

14. The system of claim 12, wherein the adjustment is automatically initiated based on a change in the acoustic environment for the hearing assistance device.

15. The system of claim 12, wherein obtaining the recommended set of parameters further comprises:
providing the features to a remote computing device; and
receiving the recommended set of parameters from the remote computing device in response to providing the features.

16. A system comprising:
memory; and
one or more processing devices configured to:
cause a user-interface to be displayed on a display device, the user-interface including one or more controls for providing information to adjust a hearing assistance device;
transmit a request for a recommended set of parameters for adjusting the hearing assistance device in an acoustic environment, the request comprising identification information associated with (i) a user of the hearing assistance device and (ii) the acoustic environment;
receive, from a remote computing device, and responsive to the request, the recommended set of parameters;
receive, via the one or more controls, information indicative of adjustments to at least a subset of the recommended set of parameters; and
provide the adjusted set of parameters to the hearing assistance device.

17. The system of claim 16, wherein the recommended set of parameters are based on parameters used by a plurality of users in different acoustic environments.

18. The system of claim 16, wherein the request for the recommended set of parameters is transmitted responsive to a user-input provided via the user-interface.

19. The system of claim 16, wherein the request for the recommended set of parameters is transmitted responsive to an automatic detection of the acoustic environment.

20. The system of claim 16 wherein the one or more processing devices are further configured to determine a plurality of features identifying characteristics of (i) the user and (ii) the acoustic environment.

21. The system of claim 16, further comprising providing the adjusted set of parameters for use in determining another recommended set of parameters.

22. The system of claim 21, wherein the one or more processing devices are further configured to store the adjusted set of parameters as a portion of a plurality of data items representing parameters used by a plurality of users in different acoustic environments.

23. One or more machine-readable storage devices having encoded thereon computer readable instructions for causing one or more processors to perform operations comprising:
receiving information indicative of an initiation of an adjustment of a hearing assistance device;
determining features associated with (i) a user of the hearing assistance device and (ii) an acoustic environment of the hearing assistance device;
obtaining, based on the features, a recommended set of parameters associated with the adjustment, wherein the recommended set of parameters are based on parameters used by a plurality of users in different acoustic environments; and
providing the recommended set of parameters to the hearing assistance device.

24. One or more machine-readable storage devices having encoded thereon computer readable instructions for causing one or more processors to perform operations comprising:
causing a user-interface to be displayed on a display device, the user-interface including one or more controls for providing information to adjust a hearing assistance device;
transmitting a request for a recommended set of parameters for adjusting the hearing assistance device in an acoustic environment, the request comprising identification information associated with (i) a user of the hearing assistance device and (ii) the acoustic environment;
receiving, from a remote computing device, and responsive to the request, the recommended set of parameters;
receiving, via the one or more controls, information indicative of adjustments to at least a subset of the recommended set of parameters; and
providing the adjusted set of parameters to the hearing assistance device.
